(19) United States
(12) Patent Application Publication
(10) Pub. No.: US 2003/0147376 A1
(43) Pub. Date: Aug. 7, 2003

(54) Rack mounted routers

(75) Inventors: John M. Coutinho, Hopkinton, MA (US); Nelson Briggs, Attleboro, MA (US); Corey DeLisle, Fitchburg, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avici Systems, Inc., North Billerica, MA

(21) Appl. No.: 10/247,774

(22) Filed: Sep. 19, 2002

Related U.S. Application Data
(60) Provisional application No. 60/327,187, filed on Oct. 4, 2001.

(51) Int. Cl. H04L 12/28

(52) U.S. Cl. 370/351; 370/353

(57) ABSTRACT

A router system includes a rack, a first array of fabric router modules interconnected in a router fabric and housed in a first housing mounted on the rack, and a second array of fabric modules interconnected in a router fabric and housed in a second housing mounted adjacent to the first housing in the rack. The first and the second arrays of fabric router modules are connected together with fabric connections to form a system router fabric.

### RELATED APPLICATION

This application claims the benefit of U.S. Provisional Application No. 60/327,187, filed Oct. 4, 2001, the entire contents of which are incorporated herein by reference.

### BACKGROUND

Computer systems come in a variety of topologies. Systems that include multiple data processing modules (or nodes) often have complex topologies. The interconnection assemblies that connect the modules of such topologies are often complicated, as well. In particular, it is a demanding task for an interconnection assembly to provide several connections (or links) to each module, as required by certain systems having mesh-shaped configurations and as a torus.

A typical multi-module computer system has an interconnection assembly that includes a backplane, module connectors and flexible wire cables. The backplane is a rigid circuit board to which the module connectors are mounted. Each module is a circuit board that electrically connects with the backplane when plugged into one of the mounted module connectors. The flexible wire cables connect with the backplane to configure the system into a network topology having a particular size.

The network topology of a typical multi-module computer system is expandable by adding another backplane and reconnecting the flexible wire cables to configure the system into a larger network topology. Generally, the topology of the system is expanded by several modules at a time. For example, one such system having a 4×4×4 torus topology is expanded by adding a 16-module backplane and reconnecting the flexible wire cables to expand the system to a 4×4×5 torus topology. As another example, in a system having 2-D mesh topology, the minimum unit of expansion is a backplane that adds four modules to the system. Some systems permit expansion by hot plugging, i.e., plugging and unplugging cables to expand the topology of the system while the power is on.

A similar topology has been used in a multi-node router as disclosed in U.S. Pat. Nos. 6,204,532 and 6,370,145, incorporated by reference in their entireties.

### SUMMARY

The present invention is directed to a router system that includes a rack, a first array of fabric router modules interconnected in a router fabric and housed in a first housing mounted on the rack, and a second array of fabric modules interconnected in a router fabric and housed in a second housing mounted adjacent to the first housing in the rack. The first and the second arrays of fabric router modules are connected together with fabric connections to form a system router fabric.

Embodiments of this aspect can include one or more of the following features. The router system may include one or more configuration controllers that select signal paths through the fabric connections. In some embodiments, the router system includes one or more power supplies that provide electrical power to the first array and the second array of fabric modules. The router system can include one or more power controllers that prevent an oversupply of power from the power supplies.

In certain embodiments, one or more cooling systems of the router system maintain the router modules within a desired operating temperature range.

The router system can be interconnected with one or more other router systems in an X-dimension, a Y-dimension, or a Z-dimension. In some embodiments, the router system is interconnected with a plurality of other router systems in all three dimensions to form a multi-mode system with a torus topology.

In another aspect of the invention, a router system includes a rack, and a first router and a second router mounted on the rack. The first router has a plurality of input/output ports, analyzes headers in packets received on input ports and routes the packets to output ports of the first router indicated by the headers. The second router also has a plurality of input/output ports, analyzes headers in packets received on input ports and routes the packets to output ports of the second router indicated by the headers. The router system further includes connections between the first and second routers to form a router system in which headers of packets received at input ports of one of the first and second routers are analyzed and the packets are forwarded through the first and second routers to an output port of the other of the routers. The output port of the other of the routers is indicated by the analysis of the header in the one of the first and second routers.

Embodiments of this aspect can include one or more configuration controllers that select signal paths through the first and second routers. In some embodiments, the router system includes one or more power supplies that provide electrical power to the first and second routers, and can include one or more power controllers that prevent an oversupply of power from the power supplies. The router system can also include one or more cooling systems that maintain the first and second routers within a desired operating temperature range.

Among other advantages, the router system can operate as a single router with the arrays of fabric router modules interconnected, or the router system can function independently as two separate routers. The router system is small in size such that it is able to provide more router capabilities in a smaller footprint. Also, because of its light weight and small size the router system can be picked up and racked mounted in existing data-processing or computer component racks, or can be stacked on top of another router system. That is, the router system does not necessarily have to sit on the floor and/or be placed on a pallet to be moved.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a perspective view of stackable, switchable router system in accordance with the invention.

FIG. 1B is illustrates two router systems stacked together in a rack.

FIG. 2 is a perspective view of a housing of the router system of FIG. 1.

FIG. 3A is a perspective view of a pair of power controllers for the router system of FIG. 1.

FIG. 3B is a top view of the inner components of the power controllers of FIG. 3A taken along the line 3B-3B of FIG. 3A.

FIG. 4A is a front view of a pair of router systems interconnected in an X-dimension.

FIG. 4B is a perspective view of a pair of router systems interconnected in a Y-dimension.

FIG. 4C is a side view of a pair of router systems interconnected in a Z-dimension.

FIG. 5A is a logical view of modules linked together for two independent routers.

FIG. 5B is a logical view of the modules of the two routers of FIG. 5A linked together forming a single router system.

### DETAILED DESCRIPTION OF THE INVENTION

A description of preferred embodiments of the invention follows.

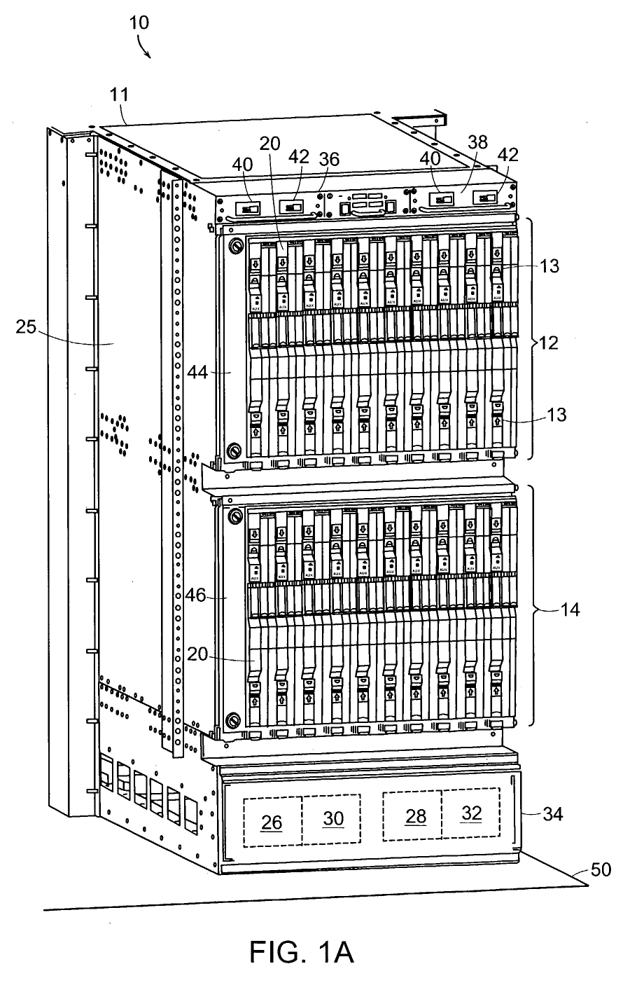

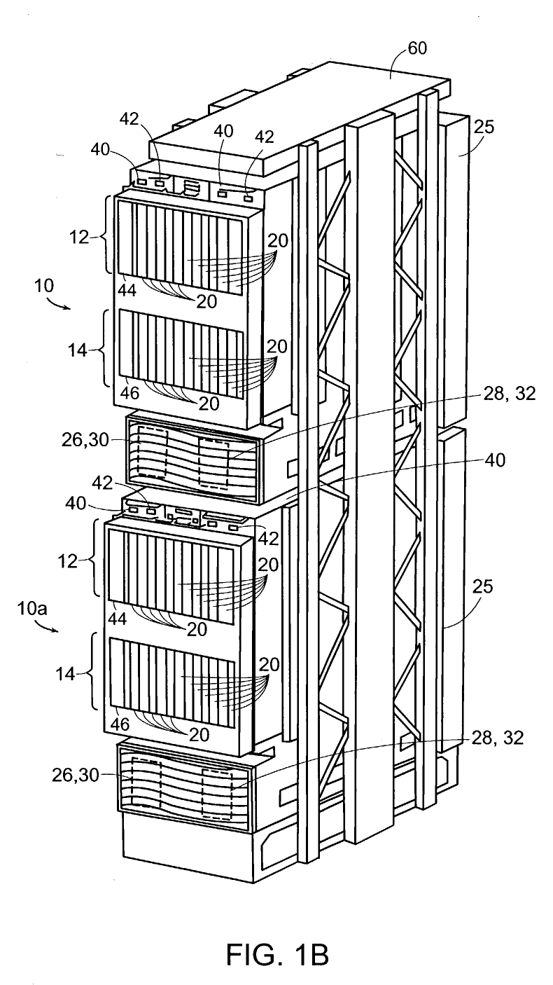

There is shown in FIG. 1A router system 10 that is, for example, interconnected with other router systems of a multi-mode data processing system such as an internet router formed by a network of fabric routers, or a multi-computer system. Internet switch routers formed by networks of fabric routers are described in U.S. Pat. No. 6,370,145, the entire teachings of which are incorporated herein by reference.

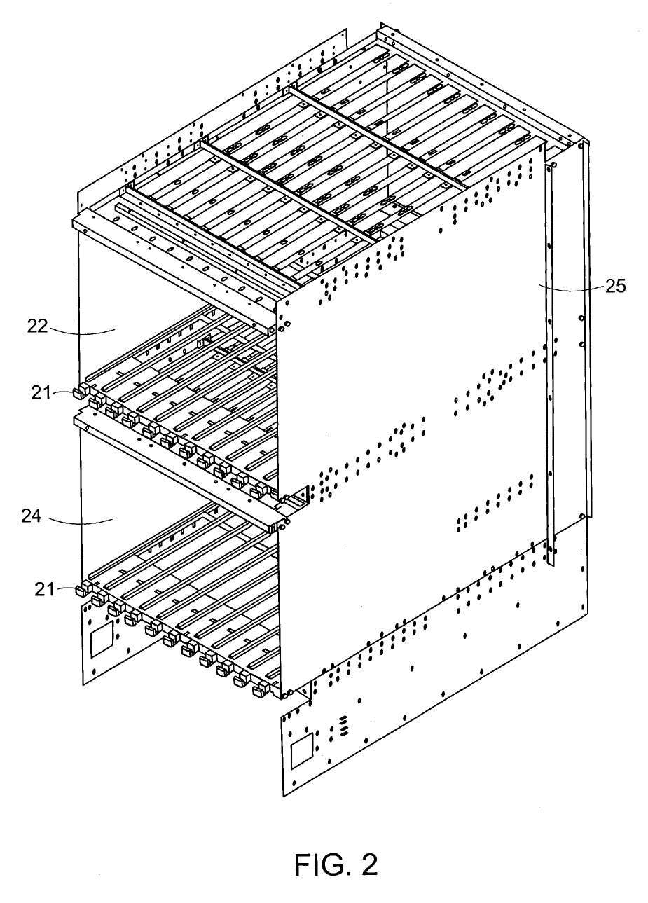

The router system 10 includes a backplane 11 on the back of a housing 25 which is provided with arrays 12 and 14 of cards 20 mounted along a respective rail 21 in an upper card cage 22 and a lower card cage 24, respectively (FIG. 2). Each array 12 and 14 includes 10 configuration cards 20, also referred to as an internet router modules. Each card or module 20 is provided with a pair of ejector latches 13, that when pulled allow the card to be pulled out from the respective cage. To lock the module 20 in place, the latches are merely pushed in to a locked position. The configuration cards 20 of the array 12 serve as fabric router modules interconnected in a router fabric. The configuration cards 20 of the lower array 14 are also interconnected in a router fabric. Further, there are fabric connections between the fabric router modules of the upper and lower arrays 12 and 14 to form a system router fabric.

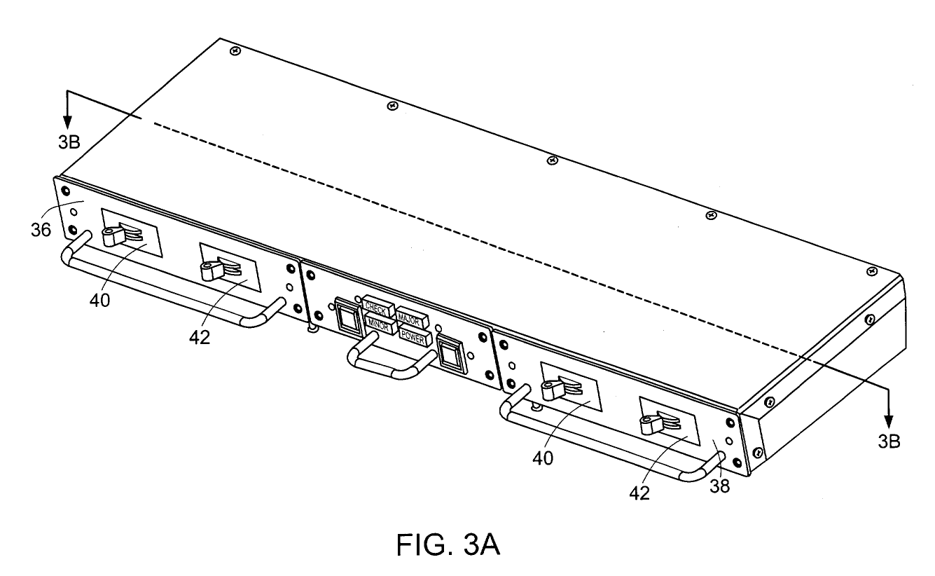

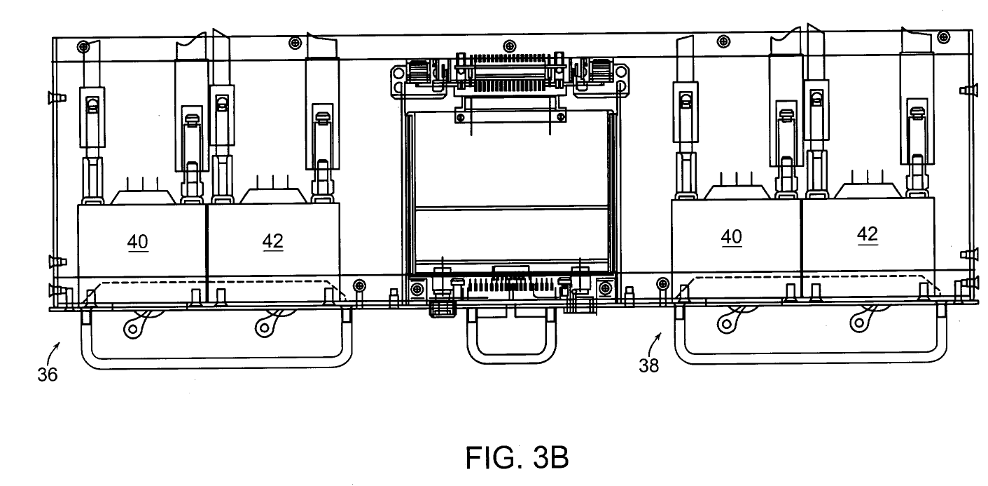

The router system 10 also includes two power sources 26 and 28 and two cooling systems 30 and 32 located in a lower bay 34 of the router system 10, and two power controllers 36 and 38 positioned at the top of the system 10. The power sources 26 and 28 provide the necessary power to the arrays 12 and 14, and the cooling systems 30 and 32 ensure that the router modules 20 are cooled so that they maintained at a desired operating temperature. Referring also to FIGS. 3A and 3B, the power controllers 36 and 38 are provided with two circuit breakers 40 and 42, one of which is typically redundant, to prevent an oversupply of power to the router modules.

In certain embodiments, each array 12 and 14 is served by a respective power source, cooling system, and power controller. For example, the array 12 can be served by the power source 26, the cooling system 30, and the power controller 36, while the array 14 is served by the power source 28, the cooling system 32, and the power controller 38. Alternatively, both arrays 12 and 14 can be served by a single power source, cooling system, and power controller, with the other power source, cooling system, and power controller functioning as backups in case one of the primary components fail.

In addition to the ten configuration cards or router modules 20, each of the arrays 12 and 14 is provided with a server or configuration controller 44 and 46, respectively. Theses configuration controllers 44 and 46 select the signal paths through the fabric connections and hence direct the flow of the signals through the router modules 20 of each array 12 and 14. Note that one of the configuration controllers 44 and 46 can serve both of the arrays 12 and 14, while the other configuration controller acts as redundant or backup controller.

The router system 10 is about four feet tall and weighs about 400 pounds. The router system 10 can sit on a floor 50 as illustrated. Alternatively, the housing 25 is configured to fit within a system rack 60 (FIG. 1A) which can hold two or more router systems 10 and/or other data-processing or computer components. The router system 10 is also stackable, that is, one router system 10 can sit on top of another system 10a without comprising the structural integrity of the lower system. The stacked router systems can function as two router systems or can be connected togther such that the they function as a single router system, as discussed below. Whether the router systems are stacked or not, they can be interconnected in a number of ways. Additional details of the router system 10 can be found in the document “Stackable Switch Router Install Guide,” by Avici Systems, Inc., of N. Billerica, Mass., the entire contents of which is incorporated herein by reference.

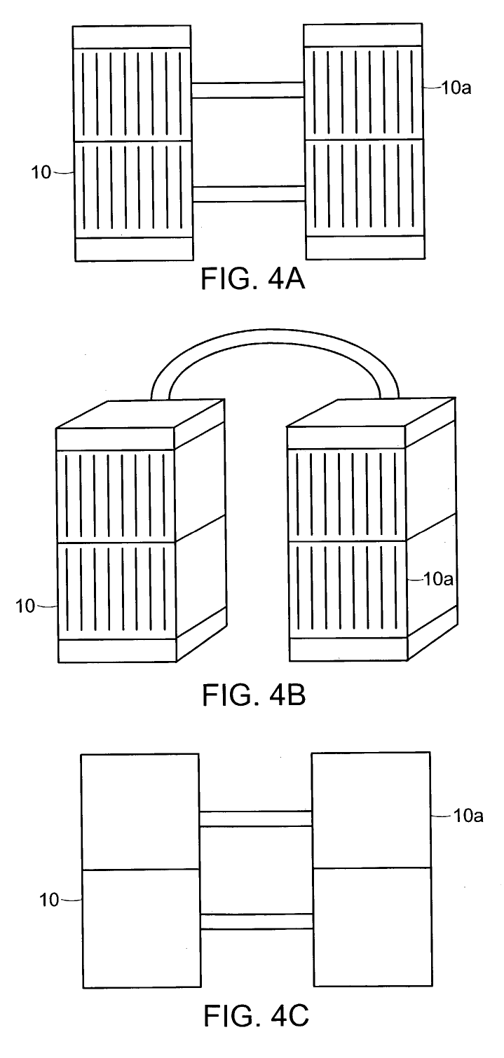

As mentioned above, the router system 10 can be interconnected with a number of other router systems of a multi-mode data-processing system or multi-computer system. For example, there is shown in FIG. 4A the router system 10 interconnected with a router system 10a in an X-dimension.

Referring now to FIG. 4B, the router system 10 is interconnected “over-the-top” with another router system 10a in a Y-dimension. And shown in FIG. 4C, the router system 10 is interconnected with another 10a in the Z-dimension. Although only two router systems are shown interconnected in each dimension of the figures of FIGS. 4A-4C, a network system can include many router systems interconnected in a particular dimension.

In some embodiments, a number of router systems 10 can be interconnected in all three dimensions to form a multi-module system with a torus topology. In such a system, one or more router systems, or backplanes or router modules of a router system can be removed or added to the multi-module system by simply switching the signal paths through the various fabric connections.

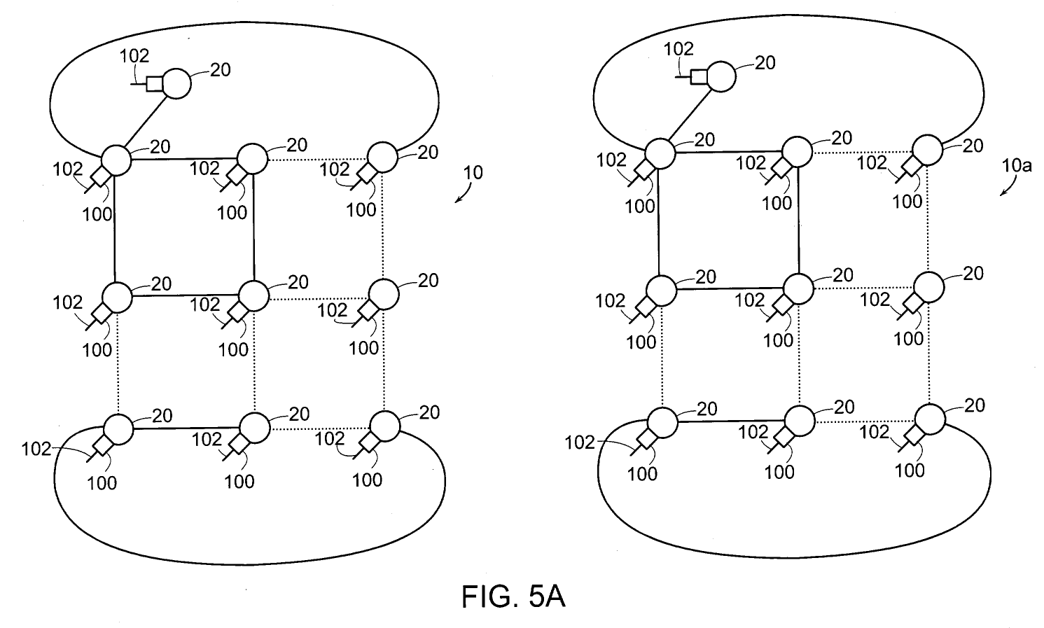

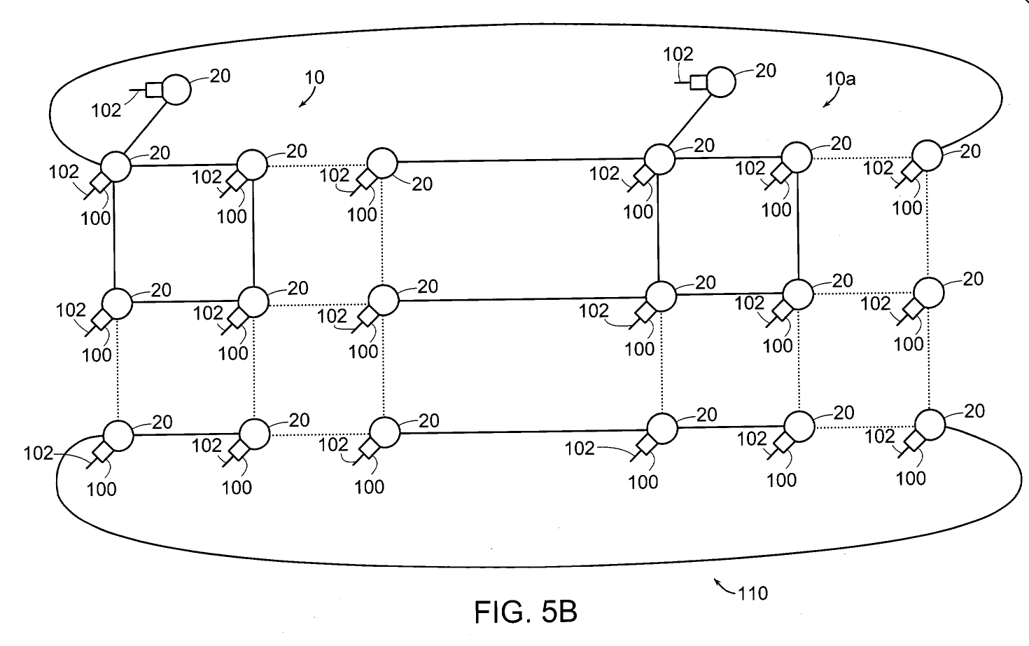

In the discussion above, the router modules 20 of the upper and lower arrays 12 and 14 are interconnected to form a system router fabric. For example, referring to FIG. 5A, there is shown logically the modules 20 interconnected to form the system 10 into, for example, a single system router fabric as a torus. Each module 20 has an interface 100 with an input/output (I/O) port 102. The interface 100 analyzes headers in packets received on respective input ports 102 and routs the packets to output ports 102 of the respective router as indicated by the headers. Also shown in FIG. 5A is another system 10a that functions as single system router fabric independently from the system 10. That is, each of the systems 10 and 10a functions as an independent router. These systems can reside, for example, in a single rack 60, as shown in FIG. 1B.

Alternatively, the systems 10 and 10a can be connected togther as discussed with reference to FIGS. 4A-4C. For example, there is shown in FIG. 5B the two routers 10 and 10a connected to form a single internet router system 110. Again, these routers 10 and 10a can reside in a single rack 60 (FIG. 1B). Thus, in the router system 110, there are connections between the routers 10 and 10a to form a router system in which headers of packets received at the input ports of the routers 10 and 10a are analyzed, and the packets are forwarded through the routers 10 and 10a to an output port, for example, of the other router. The output port of the other router is indicated by the analysis of the header in the first router.

When the two independent routers 10 and 10a shown in FIG. 5A are connected to form the single internet router system 110 of FIG. 5B, the controllers 44 and 46 are reprogrammed, for instance, to change the routing table of output ports for each input port. Moreover, the reprogrammed controller changes the internal routing table that identifies the path that weaves through the system 110 from the input port to the desired output port.

While this invention has been particularly shown and described with references to preferred embodiments thereof, it will be understood by those skilled in the art that various changes in form and details may be made therein without departing from the scope of the invention encompassed by the appended claims.

What is claimed is:

1. A router system comprising:
a rack;
a first array of fabric router modules interconnected in a router fabric and housed in a first housing mounted on the rack;
a second array of fabric modules interconnected in a router fabric and housed in a second housing mounted adjacent to the first housing in the rack; and
fabric connections between modules of the first and second arrays of fabric router modules to form a system router fabric.

2. The router system of claim 1 further comprising one or more configuration controllers that select signal paths through the fabric connections.

3. The router system of claim 1 further comprising one or more power supplies that provide electrical power to the first array and the second array of fabric modules.

4. The router system of claim 3 further comprising one or more power controllers that prevent an oversupply of power from the power supplies.

5. The router system of claim 1 further comprising one or more cooling systems that maintain the router modules within a desired operating temperature range.

6. The router system of claim 1, wherein the router system is interconnected with one or more other router systems in an X-dimension.

7. The router system of claim 1, wherein the router system is interconnected with one or more other router systems in a Y-dimension.

8. The router system of claim 1, wherein the router system is interconnected with one or more other router systems in a Z-dimension.

9. The router systems of claim 1, wherein the router system is interconnected with a plurality of other router systems in an X-dimension, a Y-dimension, and a Z-dimension to form a multi-mode system with a torus topology.

10. A router system comprising:
a rack;
a first router mounted on the rack, the first router having a plurality of input/output ports, analyzing headers in packets received on input ports and routing the packets to output ports of the first router indicated by the headers;
a second router mounted on the rack, the second router having a plurality of input/output ports, analyzing headers in packets received on input ports and routing the packets to output ports of the second router indicated by the headers; and
connections between the first and second routers to form a router system in which headers of packets received at input ports of one of the first and second routers are analyzed and the packets are forwarded through the first and second routers to an output port of the other of the routers, the output port of the other of the routers being indicated by the analysis of the header in the one of the first and second routers.

11. The router system of claim 10 further comprising one or more configuration controllers that select signal paths through the first and second routers.

12. The router system of claim 10 further comprising one or more power supplies that provide electrical power to the first and second routers.

13. The router system of claim 12 further comprising one or more power controllers that prevent an oversupply of power from the power supplies.

14. The router system of claim 10 further comprising one or more cooling systems that maintain the first and second routers within a desired operating temperature range.
